(19) United States
(12) Patent Application Publication
(10) Pub. No.: US 2026/0031021 A1
(43) Pub. Date: Jan. 29, 2026

(54) DISPLAY DEVICE

(71) Applicant: SAMSUNG DISPLAY CO., LTD., YONGIN-SI (KR)

(72) Inventors: Jin Young ROH, Yongin-si (KR); Bon Seog GU, Yongin-si (KR); Hae Kwan SEO, Yongin-si (KR); Jae Keun LIM, Yongin-si (KR)

(21) Appl. No.: 19/191,277

(22) Filed: Apr. 28, 2025

(30) Foreign Application Priority Data
Jul. 29, 2024 (KR) 10-2024-0100202

(51) Int. Cl. G09G 3/32; G09G 3/3266; G09G 3/3275

(52) U.S. Cl. CPC G09G 3/32; G09G 3/3266; G09G 3/3275; G09G 2300/0452; G09G 2310/0267; G09G 2310/0275; G09G 2310/0297; G09G 2310/08; G09G 2330/021

(57) ABSTRACT

A display device includes pixels arranged in the order of a first red pixel, a first green pixel, a first blue pixel, and a second green pixel on a first horizontal line; and pixels arranged in the order of a second blue pixel, a third green pixel, a second red pixel, and a fourth green pixel on a second horizontal line. The first red pixel and the second blue pixel located on the same vertical line are connected to different data lines, and the first green pixel and the second green pixel located on the first horizontal line are connected to different scan lines.

### CROSS-REFERENCE TO RELATED APPLICATION

The application claims priority under 35 USC § 119 (a) to and the benefit of Korean Patent Application No. 10-2024-0100202, filed on Jul. 29, 2024 with the Korean Intellectual Property Office, which is hereby incorporated by reference for all purposes as if fully set forth herein.

### BACKGROUND

### 1. Field

One or more embodiments described herein relate to a display device and an electronic device including the display device.

### 2. Discussion of the Related Art

A variety of electronic devices include displays. Examples include liquid crystal displays and organic light emitting displays. In operation, a data driver of a display device supplies data signals to pixels. The pixels may then display an image by emitting light at a predetermined luminance based on the data signals. In some displays, the data driver supplies the data signals to the pixels through a data distributor coupled to an output of the data driver. For some displays, the data distributor may include a plurality of demultiplexers which allow the number of output lines, or channels, of the data driver to be less than the number of output lines of the data distributor. As a result, the number of output channels of the data driver may be less than the number of pixels arranged on one horizontal line.

### SUMMARY

An object of the present invention is to provide a display device capable of reducing power consumption.

A display device according to embodiments of the present invention may include a plurality of pixels include pixels arranged in the order of a first red pixel, a first green pixel, a first blue pixel, and a second green pixel on a first horizontal line; and pixels arranged in the order of a second blue pixel, a third green pixel, a second red pixel, and a fourth green pixel on a second horizontal line. The first red pixel and the second blue pixel located on the same vertical line may be connected to different data lines, and the first green pixel and the second green pixel located on the first horizontal line may be connected to different scan lines.

According to one embodiment, the first green pixel and the third green pixel located on the same vertical line may be connected to different data lines, the first blue pixel and the second red pixel located on the same vertical line may be connected to different data lines, and the second green pixel and the fourth green pixel located on the same vertical line may be connected to different data lines.

According to one embodiment, the first green pixel and the third green pixel may be connected to the same scan line.

According to one embodiment, the second green pixel and the fourth green pixel may be connected to different scan lines.

According to one embodiment, the first red pixel, the first blue pixel, and the second green pixel may be connected to a first scan line, and the second blue pixel, the first green pixel, the third green pixel, and the second red pixel may be connected to a second scan line.

According to one embodiment, the display device may further include a fifth green pixel located on the same vertical line as the second green pixel above the second green pixel, and the fifth green pixel may be connected to the first scan line.

According to one embodiment, the first red pixel and the first green pixel may be connected to a first data line, the first blue pixel and the third green pixel may be connected to a second data line, the second red pixel and the fourth green pixel may be connected to a third data line, and the second green pixel may be connected to a fourth data line.

According to one embodiment, the display device may further include a third blue pixel located adjacent to the fourth green pixel in the second horizontal line and connected to the fourth data line.

According to one embodiment, the display device may further include a data driver supplying a plurality of data signals to output lines; a data distributor outputting the plurality of data signals input to the output lines to a plurality of data lines; a scan driver driving scan lines; and a timing controller controlling the data driver, the data distributor, and the scan driver.

According to one embodiment, the data distributor may include a first demultiplexer connected to a first output line among the output lines and transmitting a data signal to the first data line and the second data line; and a second demultiplexer connected to a second output line among the output lines and transmitting a data signal to the third data line and the fourth data line.

According to one embodiment, each of the first demultiplexer and the second demultiplexer may include a first transistor turned on in response to an enable first control signal supplied from the timing controller; and a second transistor turned on in response to an enable second control signal supplied from the timing controller.

According to one embodiment, the timing controller may sequentially supply the enable first control signal and the enable second control signal during a horizontal period.

According to one embodiment, the timing controller may supply the enable first control signal and then supply the enable second control signal during a first horizontal period, and may supply the enable second control signal and then supply the enable first control signal during a second horizontal period following the first horizontal period.

According to one embodiment, one frame may be divided into a first sub-frame and a second sub-frame. The scan driver may sequentially supply an enable scan signal to k-th scan lines during a first sub-frame period, and may sequentially supply an enable scan signal to (k+1)th scan lines during a second sub-frame period (k may be an odd or even number).

A display device according to embodiments of the present invention may include pixels connected to scan lines and data lines; a scan driver driving the scan lines; a data driver supplying a plurality of data signals to output lines; and a data distributor connected to the output lines and supplying the plurality of data signals in time division to the data lines. The pixels that are located on the same vertical line and emit light of different colors may be alternately connected to different data lines, and the pixels that are located on the same vertical line and different horizontal lines and emit light of a same color may be connected to the same scan line and are driven in the same sub-frames of the frame.

According to one embodiment, the pixels that emit light of the same color may be green pixels.

According to one embodiment, the green pixels located on the same horizontal line may be alternately connected to different scan lines.

According to one embodiment, one frame may be divided into a first sub-frame and a second sub-frame. The scan driver may sequentially supply an enable scan signal to odd-numbered scan lines during a first sub-frame period, and sequentially supply an enable scan signal to even-numbered scan lines during a second sub-frame period.

According to one embodiment, the data distributor may have a demultiplexer connected between one output line and two data lines, and the demultiplexer may sequentially connect the one output line to the two data lines during a horizontal period in response to an enable first control signal and an enable second control signal.

According to one embodiment, the display device may further include a timing controller supplying the enable first control signal and the enable second control signal. The timing controller may sequentially supply the enable first control signal and the enable second control signal for each horizontal period, or may change the order in which the enable first control signal and the enable second control signal are supplied for each horizontal period.

According to one embodiment, an electronic device comprising: a plurality of pixels; a data driver configured to output color data signals; a distributor configured to provide the color data signals to data lines connected to the plurality of pixels, wherein the plurality of pixels are to be driven in an interlaced scanning pattern. The plurality of pixels include: pixels arranged in an order of a first red pixel, a first green pixel, a first blue pixel, and a second green pixel on a first horizontal line, the first red pixel, the first blue pixel, and the second green pixel to emit light during a first sub-frame period; and pixels arranged in the order of a second blue pixel, a third green pixel, a second red pixel, and a fourth green pixel on a second horizontal line, the first green pixel, the second blue pixel, the third green pixel and the second red pixel to emit light during a second sub-frame period. The first red pixel and the second blue pixel located on the same vertical line are connected to different data lines, and the first green pixel and the second green pixel located on the first horizontal line are connected to different scan lines.

The first green pixel and the third green pixel may be located on the same vertical line are connected to different data lines, the first blue pixel and the second red pixel may be located on the same vertical line are connected to different data lines, and the second green pixel and the fourth green pixel may be located on the same vertical line are connected to different data lines. The first green pixel and the third green pixel may be connected to the same scan line. The second green pixel and the fourth green pixel may be connected to different scan lines. The first red pixel, the first blue pixel, and the second green pixel may be connected to a first scan line, and the second blue pixel, the first green pixel, the third green pixel, and the second red pixel may be connected to a second scan line.

Objects of the present invention are not limited to the object mentioned above, and other technical objects not mentioned will be clearly understood by those skilled in the art from the description below.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a diagram illustrating a display device according to an embodiment of the present invention.

FIG. 2 is a diagram illustrating a pixel according to an embodiment of the present invention.

FIG. 3 is a diagram illustrating an arrangement structure of pixels according to an embodiment of the present invention.

FIG. 4 is a diagram illustrating a scan driver according to an embodiment of the present invention.

FIG. 5 is a waveform diagram illustrating an embodiment of the operation process of the scan driver shown in FIG. 4.

FIGS. 6A and 6B are diagrams illustrating a data signal supplied to data lines by a data distributor according to an embodiment.

FIG. 7 is a diagram illustrating voltages supplied to output lines and data lines according to the driving method of FIGS. 6A and 6B according to embodiments.

FIGS. 8A and 8B are diagrams illustrating a data signal supplied to data lines by a data distributor according to an embodiment.

FIG. 9 is a diagram illustrating voltages supplied to output lines and data lines according to the driving method of FIGS. 8A and 8B according to embodiments.

FIG. 10 is a diagram illustrating an electronic device according to an embodiment of the present invention.

### DETAILED DESCRIPTION OF THE ILLUSTRATED EMBODIMENTS

Hereinafter, various embodiments of the present invention will be described in detail with reference to the accompanying drawings so that those of ordinary skill in the art may easily implement the present invention. The present invention may be embodied in various different forms and is not limited to the embodiments described herein.

In order to clearly describe the present invention, parts that are not related to the description are omitted, and the same or similar components are denoted by the same reference numerals throughout the specification. Therefore, the reference numerals described above may also be used in other drawings.

In addition, in the description, the expression “is the same” may mean “substantially the same”. That is, it may be the same enough to convince those of ordinary skill in the art to be the same. In other expressions, “substantially” may be omitted.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, and may optionally be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the inventive concept. In addition, in some embodiments, the block, unit and/or module may be physically combined into more complex blocks, units, and/or modules without departing from the scope of the inventive concept.

The term “connection” between two components may mean that both of an electrical connection and a physical connection are used inclusively, but the present invention is not limited thereto. For example, “connection” used based on a circuit diagram may mean an electrical connection, and “connection” used based on a cross-sectional view and a plan view may mean a physical connection.

Although a first, a second, and the like are used to describe various components, these components are not limited by these terms. These terms are used only to distinguish one component from another component. Therefore, a first component described below may be a second component within the technical spirit of the present invention.

Meanwhile, the present invention is not limited to the embodiments disclosed below, and may be modified in various forms and may be implemented. In addition, each of the embodiments disclosed below may be implemented alone or in combination with at least one of other embodiments.

A display device may include a plurality of pixels that are connected to scan lines and data lines. Each scan line drives pixels located on a same horizontal line, and the data lines provide color data signals to the pixels. A data distributor may be located between a data driver that provides the color data signals and the data lines. The data distributor may include, for example, a plurality of demultiplexers that are controlled by clock signals, and the data driver may have a number of output lines less than the number of data lines.

The display device may operate in units of frames. Each frame may be divided into sub-frames. In operation, color pixels on odd-numbered horizontal lines may be driven in one sub-frame and color pixels on even-numbered horizontal lines may be driven in another or subsequent sub-frame. However, when different color data signals are supplied to each of the data lines during each sub-frame period, power consumption of the display device is increased.

In accordance with one or more embodiments, the display device includes a plurality of scan lines and data lines which are connected to a plurality of pixels in a Pentile™ arrangement. The Pentile™ arrangement corresponds to an RGBG pattern. For example, the pixels may be arranged so that a first red pixel and a second blue pixel are located on a same vertical line and are connected to different data lines, and a first green pixel and a second green pixel are located on the first horizontal line and are connected to different scan lines.

The pixels may be driven in an interlacing manner in units of frames. Each frame may be divided into a first sub-frame and a second sub-frame. In operation, color pixels on odd-numbered horizontal lines may be driven in the first sub-frame and color pixels on even-numbered horizontal lines may be driven in the second sub-frame. Advantageously, each data line may receive data signals of a same color during each of the first sub-frame period and the second sub-frame period. As a result, power consumption of the display device may be reduced or minimized.

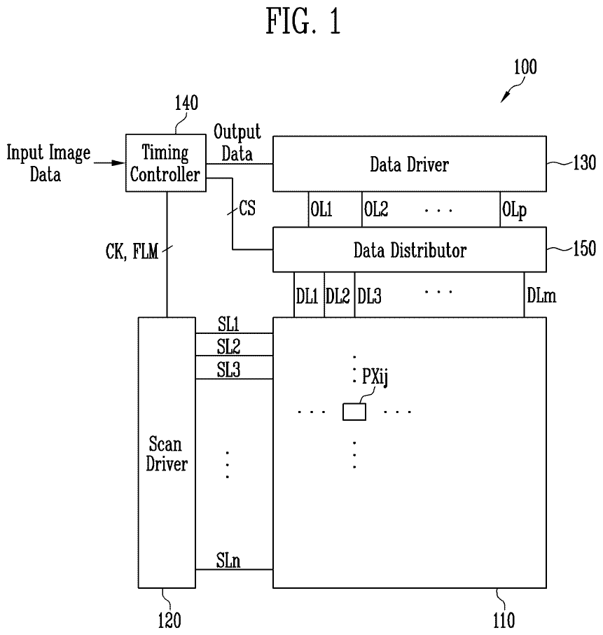

FIG. 1 is a diagram illustrating a display device 100 according to an embodiment of the present invention.

Referring to FIG. 1, the display device 100 according to one embodiment of the present invention may include a display unit 110 (or a display panel), a scan driver 120, a data driver 130, a timing controller 140, and a data distributor 150.

The timing controller 140 may receive input image data from an external processor, or host device, and control signals for displaying images for each of a plurality of frames. In one embodiment, the timing controller 140 may correct the input image data to generate output data and supply the output data to the data driver 130. In addition, the timing controller 140 may control the scan driver 120, the data driver 130, and the data distributor 150 in response to the control signals.

The data driver 130 may generate data signals corresponding to the output data and provide the data signals to output lines OL1, OL2, . . . , and OLp, where p may be a natural number greater than or equal to 3 and less than or equal to m. For example, the data driver 130 may sample the output data using a clock signal and supply the data signals corresponding to the output data to the output lines OL1 to OLp. Here, the data driver 130 may supply a plurality of data signals to each of the output lines OL1 to OLp during one horizontal period.

The data distributor 150 may be connected to the data driver 130 via the output lines OL1 to OLp. The data distributor 150 may be connected to pixels via data lines DL1, DL2, DL3, . . . , and DLm, where m may be a natural number greater than or equal to 4. As shown in FIG. 1, the number of output lines OL1 to OLp is less than the number of data lines DL1, DL2, DL3, . . . , and DLm. The data distributor 150 may have a plurality of demultiplexers (DeMUXs).

The data distributor 150 may selectively connect the output lines OL1 to OLp to the data lines DL1 to DLm. As an example, in response to a control signal CS of the timing controller 140, the data distributor 150 may electrically connect each of the output lines OL1 to OLp to two or more data lines (two or more of DL1 to DLm) during one horizontal period. During one horizontal period, each of the data lines DL1 to DLm may receive a data signal from an output line (one of OL1 to Olp) connected thereto.

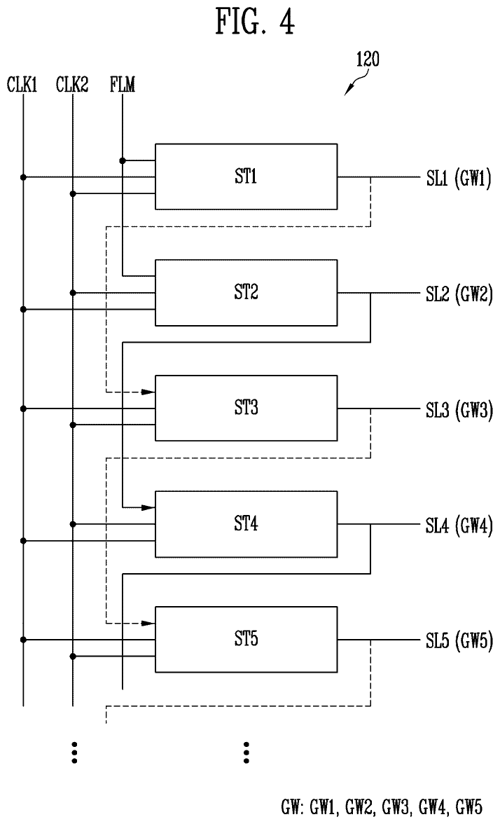

The scan driver 120 may receive at least one clock signal CK (e.g., clock signals CLK1 and CLK2) and a scan start signal FLM from the timing controller 140. (The clock signals and scan start signal are discussed in greater detail below with reference to FIG. 4.) The scan driver 120 may supply an enable scan signal to scan lines SL1, SL2, SL3, . . . , and SLn while shifting the scan start signal in response to the clock signal, where n may be a natural number greater than 4. Here, the enable scan signal may correspond to a gate-on voltage of a transistor of a pixel circuit in each of the plurality of pixels. As an example, when the enable scan signal is supplied to a P-type transistor, the enable scan signal may be set to a logic low voltage.

The scan driver 120 may supply a scan signal to the scan lines SL1 to SLn in a predetermined manner, e.g., in an interlaced scanning pattern. As an example, the scan driver 120 may sequentially supply the enable scan signal to a k-th (k may be an odd number) scan lines SL1, SL3, . . . , and then sequentially supply the enable scan signal to a (k+1)th (that is, even number) scan lines SL2, . . . , SLn.

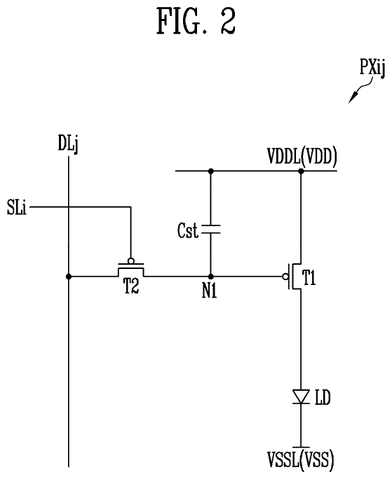

The display unit 110 may have pixels connected to the scan lines SL1 to SLn and the data lines DL1 to DLm. Each pixel PXij may be connected to a corresponding data line and scan line, where i and j may be natural numbers greater than 1. (The pixel PXij may refer to a pixel connected to an i-th scan line and a j-th data line.) The pixels of the display unit 110 may be commonly connected to a first power source line VDDL and a second power source line VSSL (see FIG. 2). A first driving power source VDD may be supplied to the first power source line VDDL, and a second driving power source VSS may be supplied to the second power source line VSSL. When the pixel PXij is set to a state of emitting light, the first driving power source VDD may be set to a higher voltage than the second driving power source VSS.

FIG. 2 is a diagram illustrating the pixel PXij according to an embodiment of the present invention. Embodiments of the present invention are not limited to the pixel shown in FIG. 2, and pixels having various circuit configurations may be included in the display unit 110.

Referring to FIG. 2, a pixel PXij according to one embodiment of the present invention may be a pixel emitting light of a first color. Pixels emitting light of a second color or light of a third color may have substantially the same configuration as the pixel PXij except for a light emitting element LD. Therefore, a duplicate description thereof will be omitted.

For example, the first color may be one of red, green, or blue. The second color may be one of red, green, or blue other than the first color, and the third color may be one of red, green, or blue other than the first and second colors. In addition, the first to third colors may be different combination of colors, e.g., magenta, cyan, and yellow instead of red, green, and blue.

The pixel PXij may have a plurality of transistors T1 and T2, a storage capacitor Cst and a light emitting element LD. In embodiments of the present invention, transistors are shown as P-type transistors, for example, PMOS transistors, but one of ordinary skill in the art will be able to construct a pixel circuit that performs the same function using N-type transistors, for example, NMOS transistors.

A first electrode of a first transistor (e.g., driving transistor) T1 may be connected to the first power source line VDDL, and a second electrode of the first transistor T1 may be connected to a first electrode (or anode electrode) of the light emitting element LD. In addition, a gate electrode of the first transistor T1 may be connected to a first node N1. The first transistor T1 may control the amount of current supplied from the first power source line VDDL to the second power source line VSSL, via the light emitting element LD, in response to a voltage of the first node N1. This amount of current may correspond to the luminance of light to be emitted from the light emitting element LD.

A first electrode of a second transistor (or switching transistor) T2 may be connected to a data line DLj, and a second electrode of the second transistor T2 may be connected to the first node N1. In addition, a gate electrode of the second transistor T2 may be connected to a scan line SLi. When an enable scan signal is supplied to the scan line SLi, the second transistor T2 may be turned on to electrically connect the data line DLj and the first node N1.

The storage capacitor Cst may be connected between the first power source line VDDL and the first node N1. The storage capacitor Cst may store the voltage of the first node N1.

The first electrode (or anode electrode) of the light emitting element LD may be connected to the second electrode of the first transistor T1, and a second electrode (or cathode electrode) of the light emitting element LD may be connected to the second power source line VSSL. The light emitting element LD may emit light of a first color having a predetermined luminance corresponding to the amount of current supplied from the first transistor T1.

The light emitting element LD may be composed of an organic light emitting diode (OLED) or an inorganic light emitting diode such as a micro light emitting diode (LED) or a quantum dot light emitting diode. In addition, the light emitting element LD may be an element composed of a composite of organic and inorganic materials. In the present embodiment, only one light emitting element LD is shown, but a plurality of sub-light emitting elements may be connected in series, in parallel, or in series and parallel to replace the light emitting element LD.

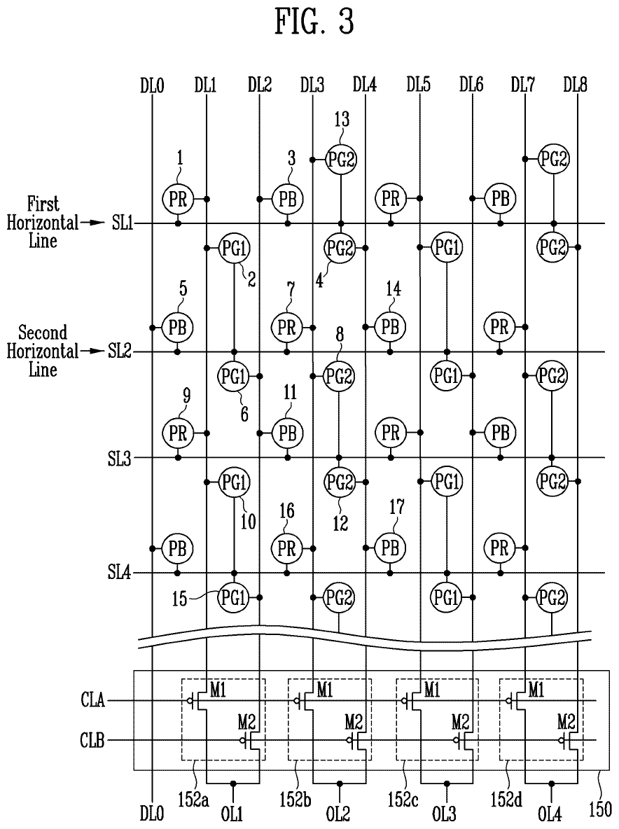

FIG. 3 is a diagram illustrating an arrangement structure of pixels in the display unit 110 according to an embodiment of the present invention.

Referring to FIG. 3, the display unit 110 may include a plurality of pixels, which may include a red pixel PR, green pixels PG1 and PG2, and a blue pixel PB. The pixels may be arranged in a PENTILE™ shape, e.g., in an RGBG configuration. For example, a first red pixel 1, a first green pixel 2, a first blue pixel 3, and a second green pixel 4 may be sequentially arranged in a first horizontal line SL1. (Here, a horizontal line may corresponds to pixels that are physically adjacent to each other along scan lines SL1 to SL4 (or along a direction of scan lines)). Pixels that are located in the same horizontal line may not all be connected to the same scan line. For example, in FIG. 3, the first red pixel 1, the first blue pixel 3, and the second green pixel 4 may be connected to scan line SL1, and the first green pixel 2 may be connected to scan line SL2 in a second horizontal line.

A second blue pixel 5, a third green pixel 6, a second red pixel 7, and a fourth green pixel 8 may be sequentially arranged in a second horizontal line. In this case, the second blue pixel 5, the third green pixel 6, and the second red pixel 7 are connected to a same scan line SL2 and the fourth green pixel 8 is connected to another scan line SL3 in another horizontal line.

In this case, the red pixel PR and blue pixels PB may be alternately arranged on odd-numbered (or even-numbered) vertical lines. In addition, the green pixels PG1 and PG2 may be arranged on even-numbered (or odd-numbered) vertical lines.

The red pixels PR and the blue pixels PB located on the same vertical line may be connected to different data lines. As an example, the first red pixel 1 located on the first vertical line may be connected to a first data line DL1, and the second blue pixel 5 may be connected to a 0-th data line DL0. As an example, the first blue pixel 3 located on the third vertical line may be connected to a second data line DL2, and the second red pixel 7 may be connected to a third data line DL3.

The green pixels PG1 and PG2 located on the same vertical line may be alternately connected to different data lines. As an example, the first green pixel 2 located on the second vertical line may be connected to the first data line DL1, and the third green pixel 6 located on the second vertical line may be connected to the second data line DL2. As an example, the second green pixel 4 located on the fourth vertical line may be connected to a fourth data line DL4, and the fourth green pixel 8 located on the fourth vertical line may be connected to the third data line DL3. Additionally, a third blue pixel 14 located adjacent to the fourth green pixel 8 on the second horizontal line may be connected to the fourth data line DL4.

The first green pixel 2 and the second green pixel 4 located on the first horizontal line may be connected to different scan lines. As an example, the first green pixel 2 may be connected to a second scan line SL2, and the second green pixel 4 may be connected to a first scan line SL1.

The third green pixel 6 and the fourth green pixel 8 located on the second horizontal line may be connected to different scan lines. As an example, the third green pixel 6 may be connected to the second scan line SL2, and the fourth green pixel 8 may be connected to a third scan line SL3. In this case, the first green pixel 2 (that is, the first green pixel 2 located on the first horizontal line) and the third green pixel 6 (that is, the third green pixel 6 located on the second horizontal line) located on different horizontal lines may be connected to the same scan line (that is, the second scan line SL2). In addition, the second green pixel 4 and the fourth green pixel 8 located on different horizontal lines may be connected to different scan lines, e.g., scan lines SL1 and SL3, respectively.

In one embodiment, the first red pixel 1, the first blue pixel 3, and the second green pixel 4 located on the first horizontal line may be connected to the first scan line SL1. In addition, a fifth green pixel 13 located on the same vertical line as the second green pixel 4 (above the second green pixel 4) may be connected to the first scan line SL1. In one embodiment, the first green pixel 2 located on the first horizontal line and the second blue pixel 5, the third green pixel 6, and the second red pixel 7 located on the second horizontal line may be connected to the second scan line SL2. In addition, the fourth green pixel 8 located on the second horizontal line may be connected to the third scan line SL3.

In odd-numbered horizontal lines including a third horizontal line (parallel to scan line SL3), pixels may be arranged in the same form as in the first horizontal line. In even-numbered horizontal lines including a fourth horizontal line (parallel to scan line SL4), pixels may be arranged in the same form as in the second horizontal line.

In one embodiment, pixels located on the same vertical line and emitting light of different colors (that is, the red pixel PR and the blue pixel PB) may be alternately connected to different data lines.

In one embodiment, green pixels located on the same horizontal line may be alternately connected to different scan lines.

In one embodiment, pixels located on the same vertical line and emitting light of the same color (that is, the green pixels PG1 and PG2) may be connected to different data lines. In addition, pixels located on the same vertical line and different horizontal lines and emitting light of the same color (that is, the green pixels PG1 and PG2) may be connected to the same scan line. As an example, the first green pixel 2 and the third green pixel 6 located on the same vertical line and different horizontal lines may be connected to the same scan line SL2 but different data lines. As an example, the fifth green pixel 13 and the second green pixel 4 located on the same vertical line and different horizontal lines may be connected to the same scan line SL1 but different data lines.

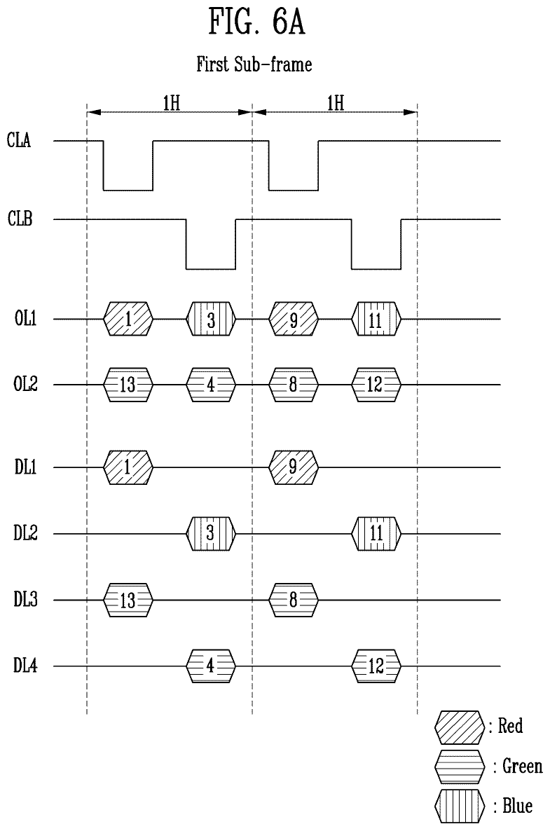

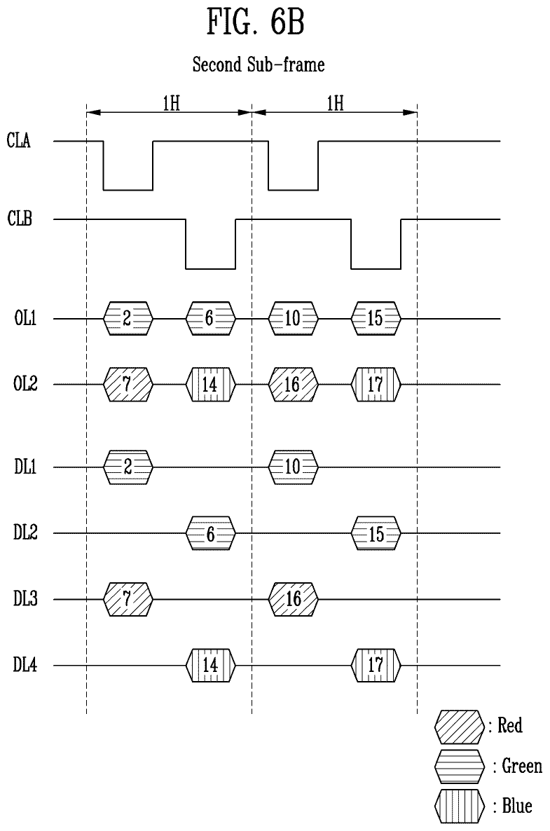

When pixels are arranged as described above and driven by applying different color data signals to a same data line during sub-frames of a frame unit, power consumption can be reduced or minimized when supplying data signals to the data lines DL1 to DLm using the data distributor 150. A detailed description in this regard will be described later with reference to FIGS. 6A to 9, which describe supplying same color data signals to each data line during sub-frames of a frame unit

The data distributor 150 may have a plurality of demultiplexers 152a, 152b, 152c, and 152d. In this example, the data distributor 150 is shown to have four demultiplexers, but may have a different number of demultiplexers in another embodiment. Each of the demultiplexers 152a, 152b, 152c, and 152d may transmit multiple (e.g., two) data signals supplied to one output line OL1 to OL4 to two data lines (two of DL1 to DL8). That is, each of the demultiplexers 152a, 152b, 152c, and 152d may be a 1:2 demultiplexer.

A first demultiplexer 152a may time-divide the data signal from a first output line OL1 and supply the time-divided data signal to the first data line DL1 and the second data line DL2. A second demultiplexer 152b may time-divide the data signal from a second output line OL2 and supply the time-divided data signal to the third data line DL3 and the fourth data line DL4. A third demultiplexer 152c may time-divide the data signal from a third output line OL3 and supply the time-divided data signal to a fifth data line DL5 and a sixth data line DL6. A fourth demultiplexer 152d may time-divide the data signal from a fourth output line OL4 and supply the time-divided data signal to a seventh data line DL7 and an eighth data line DL8.

Each of the demultiplexers 152a, 152b, 152c, and 152d may include a plurality of switches, e.g., a first transistor M1 and a second transistor M2, one corresponding to each data line. For example, each of first transistors M1 may be connected between one of the output lines OL1 to OL4 and an odd-numbered one of the data lines DL1, DL3, DL5, and DL7. The first transistor M1 may be turned on by an enable first control signal CLA supplied from the timing controller 140. Here, the enable first control signal CLA may have a gate-on voltage so that the first transistor M1 can be turned on. As an example, when the first transistor M1 is a P-type transistor, the enable first control signal CLA may have a logic low level.

Each of second transistors M2 may be connected between one of the output lines OL1 to OL4 and one of the even-numbered data lines DL2, DL4, DL6, and DL8. The second transistor M2 may be turned on by an enable second control signal CLB supplied from the timing controller 140. Here, the enable second control signal CLB may have a gate-on voltage so that the second transistor M2 can be turned on. As an example, when the second transistor M2 is a P-type transistor, the enable second control signal CLB may have a logic low level. (Referring to FIG. 1, the control signal CS may include control signal CLA and control signal CLB).

Meanwhile, a first dummy data line DL0 may be directly connected to the data driver 130 without a separate demultiplexer. In this case, the data line DL0 may directly receive the data signal from the data driver 130. However, embodiment of the present invention is not limited thereto, and the first dummy data line DL0 may be omitted.

In addition, although not shown in FIG. 3, a second dummy data line may be additionally formed adjacent to an m-th data line DLm. In this case, the first dummy data line DL0 may be connected to the data driver 130 via the first transistor M1, and the second dummy data line may be connected to the data driver 130 via the second transistor M2. That is, the first dummy data line DL0 and the second dummy data line may receive the data signal while being controlled by one demultiplexer.

FIG. 4 is a diagram illustrating the scan driver 120 according to an embodiment of the present invention.

Referring to FIG. 4, the scan driver 120 according to one embodiment of the present invention may include stage circuits ST1, ST2, ST3, ST4, ST5, . . . . Each of the stage circuits ST1 to ST5 may be electrically connected to one scan line (one of SL1, SL2, SL3, SL4, and SL5). Each of the stage circuits ST1 to ST5 may supply a scan signal GW to a scan line (one of SL1 to SL5) connected thereto.

The stage circuits ST1 to ST5 may receive clock signals CLK1 and CLK2. Odd-numbered stage circuits ST1, ST3, ST5, . . . may receive a first clock signal CLK1 through a first input terminal and may receive a second clock signal CLK2 through a second input terminal. Even-numbered stage circuits ST2, ST4, . . . may receive the second clock signal CLK2 through a first input terminal and may receive the first clock signal CLK1 through a second input terminal.

A first stage circuit ST1 may receive a start signal FLM and output a scan signal GW1 while shifting the start signal FLM in response to the clock signals CLK1 and CLK2. A carry signal (or the scan signal GW1) output from the first stage circuit ST1 may be supplied to a third stage circuit ST3. That is, odd-numbered stage circuits ST3, ST5, . . . may receive a carry signal from a previous odd-numbered stage circuit.

A second stage circuit ST2 may receive the start signal FLM and output the scan signal GW while shifting the start signal FLM in response to the clock signals CLK2 and CLK1. A carry signal (or a scan signal GW2) output from the second stage circuit ST2 may be supplied to a fourth stage circuit ST4. That is, even-numbered stage circuits ST4, . . . may receive a carry signal from a previous even-numbered stage circuit.

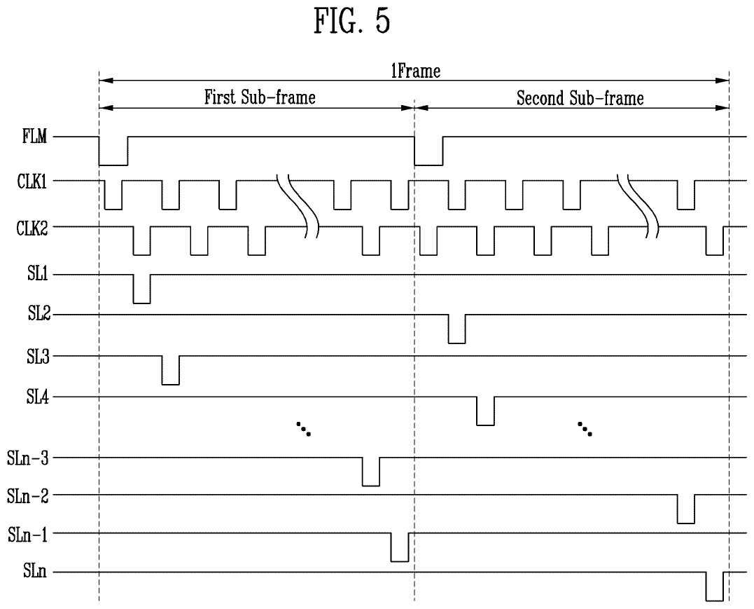

FIG. 5 is a waveform diagram illustrating an embodiment of the operation process of the scan driver 120 shown in FIG. 4.

Referring to FIG. 5, the first clock signal CLK1 and the second clock signal CLK2 may have the same cycle (and pulse width) and different phases. As an example, the first clock signal CLK1 and the second clock signal CLK2 may have a phase difference of 180 degrees.

One frame period (1 Frame) may be divided into a first sub-frame period and a second sub-frame period and driven. In the first sub-frame period, odd-numbered scan lines may be driven, and in the second sub-frame period, even-numbered scan lines may be driven.

For example, during the first sub-frame period, the start signal FLM may be supplied so as to overlap with the first clock signal CLK1 of a low voltage. The first stage circuit ST1 receives the start signal FLM so as to overlap with the first clock signal CLK1 and may output an enable scan signal GW1 to the first scan line SL1. In addition, the carry signal may be supplied from the first stage circuit ST1 to the third stage circuit ST3. The third stage circuit ST3 may output an enable scan signal GW3 to the third scan line SL3 in response to the clock signals CLK1 and CLK2. That is, during the first sub-frame period, an enable scan signal GW may be supplied to odd-numbered scan lines SL1, SL3, . . . , SLn−3, and SLn−1.

During the second sub-frame period, the start signal FLM may be supplied so as to overlap with the second clock signal CLK2 of a low voltage. The second stage circuit ST2 receiving the start signal FLM so as to overlap with the second clock signal CLK2 may output an enable scan signal GW2 to the second scan line SL2. In addition, the carry signal may be supplied from the second stage circuit ST2 to the fourth stage circuit ST4. The fourth stage circuit ST4 may output an enable scan signal GW4 to the fourth scan line SL4 in response to the clock signals CLK1 and CLK2. That is, during the second sub-frame period, the scan signal GW may be supplied to even-numbered scan lines SL2, SL4, . . . , SLn−2, and SLn.

Thus, the scan driver 120 according to one embodiment of the present invention may supply the enable scan signal GW in an interlaced scanning pattern. In the embodiment of the present invention, the scan driver 120 may be configured in various forms that can supply the enable scan signal GW in an interlaced scanning pattern.

FIGS. 6A and 6B are diagrams illustrating data signals supplied to data lines by the data distributor 150. In FIG. 6A and FIG. 6B, the operation process will be described using data signals supplied to the first output line OL1 and the second output line OL2. The operation process may be explained with the PENTILE™ arrangement (RGBG) of pixels shown with reference to FIG. 3. Furthermore, while each data line DL1 to DL4 is connected to pixels of different colors, the pixels are driven so that data signals corresponding to the same color are supplied to each of the data lines DL1 to DL4 during the same sub-frame period.

Referring to FIG. 6A, during the first sub-frame period, the enable scan signal GW may be sequentially supplied to the odd-numbered scan lines SL1, SL3, . . . . The enable first control signal CLA and the enable second control signal CLB may be sequentially supplied during a horizontal period 1H. As an example, during the horizontal period 1H, the enable first control signal CLA may be supplied and then the enable second control signal CLB may be supplied.

During a first horizontal period, the enable scan signal GW1 may be supplied to the first scan line SL1 (e.g., see FIG. 3). Then, the second transistor T2 included in each of the pixels connected to the first scan line SL1 may be set to a turned-on state.

When the enable first control signal CLA is supplied during the first horizontal period, the first transistor M1 in the data distributor 150 may be turned on. When the first transistor M1 is turned on, the first output line OL1 may be electrically connected to the first data line DL1, and the second output line OL2 may be electrically connected to the third data line DL3. In this case, the data signal supplied to the first output line OL1 may be supplied to the first red pixel 1 via the first data line DL1, and the data signal supplied to the second output line OL2 may be supplied to the fifth green pixel 13 via the third data line DL3.

When the enable second control signal CLB is supplied during the first horizontal period, the second transistor M2 in the data distributor 150 may be turned on. When the second transistor M2 is turned on, the first output line OL1 may be electrically connected to the second data line DL2, and the second output line OL2 may be electrically connected to the fourth data line DL4. In this case, the data signal supplied to the first output line OL1 may be supplied to the first blue pixel 3 via the second data line DL2, and the data signal supplied to the second output line OL2 may be supplied to the second green pixel 4 via the fourth data line DL4. Thus, during the first horizontal period of the first sub-frame, the first red pixel 1, the fifth green pixel 13, the first blue pixel 3 and the second green pixel 4 may emit light, as all of these pixels are connected to the first can line SL1 when corresponding ones of the data signals are supplied from the data distributor 150.

During a second horizontal period of the first sub-frame, the enable scan signal GW3 may be supplied to the third scan line SL3, e.g., see FIG. 3. Then, the second transistor T2 included in each of the pixels connected to the third scan line SL3 may be set to a turned-on state.

When the enable first control signal CLA is supplied during the second horizontal period, the first transistor M1 in the data distributor may turned on. In this case, the data signal supplied to the first output line OL1 may be supplied to a red pixel 9 via the first data line DL1, and the data signal supplied to the second output line OL2 may be supplied to the fourth green pixel 8 via the third data line DL3.

When the enable second control signal CLB is supplied during the second horizontal period, the second transistor M2 may be turned on. In this case, the data signal supplied to the first output line OL1 may be supplied to a blue pixel 11 via the second data line DL2, and the data signal supplied to the second output line OL2 may be supplied to a green pixel 12 via the fourth data line DL4.

Thus, during the first sub-frame period, data signals corresponding to the same color may be supplied to each of the data lines DL1 to DL4. As an example, data signals corresponding to red may be supplied to the first data line DL1 (e.g., for driving the red pixels 1 and 9), data signals corresponding to blue may be supplied to the second data line DL2 (e.g., for driving blue sub-pixels 3 and 11), and data signals corresponding to green may be supplied to the third data line DL3 and the fourth data line DL4 (for driving green sub-pixels 13, 8, 4 and 12).

That is, in one embodiment of the present invention, data signals corresponding to the same color may be supplied to each of the data lines DL1 to DL4 during the first sub-frame period, thereby reducing or minimizing power consumption. Additionally, data signals corresponding to red and blue may be alternately supplied to the first output line OL1, and the data signal corresponding to green may be supplied to the second output line OL2.

Referring to FIG. 6B, during the second sub-frame period, the enable scan signal GW may be sequentially supplied to the even-numbered scan lines SL2, SL4, . . . .

During the first horizontal period, the enable scan signal GW2 may be supplied to the second scan line SL2. Then, the second transistor T2 included in each of the pixels connected to the second scan line SL2 may be set to a turned-on state.

When the enable first control signal CLA is supplied during the first horizontal period, the first transistor M1 of the data distributor 150 may be turned on. When the first transistor M1 is turned on, the first output line OL1 may be electrically connected to the first data line DL1, and the second output line OL2 may be electrically connected to the third data line DL3. In this case, the data signal supplied to the first output line OL1 may be supplied to the first green pixel 2 via the first data line DL1, and the data signal supplied to the second output line OL2 may be supplied to the second red pixel 7 via the third data line DL3.

When the enable second control signal CLB is supplied during the first horizontal period, the second transistor M2 may be turned on. When the second transistor M2 is turned on, the first output line OL1 may be electrically connected to the second data line DL2, and the second output line OL2 may be electrically connected to the fourth data line DL4. In this case, the data signal supplied to the first output line OL1 may be supplied to the third green pixel 6 via the second data line DL2, and the data signal supplied to the second output line OL2 may be supplied to the third blue pixel 14 via the fourth data line DL4.

During the second horizontal period, the enable scan signal GW4 may be supplied to the fourth scan line SL4. Then, the second transistor T2 included in each of the pixels connected to the fourth scan line SL4 may be set to a turned-on state.

When the enable first control signal CLA is supplied during the second horizontal period, the first transistor M1 may be turned on. In this case, the data signal supplied to the first output line OL1 may be supplied to a green pixel 10 via the first data line DL1, and the data signal supplied to the second output line OL2 may be supplied to a red pixel 16 via the third data line DL3.

When the second enable control signal CLB is supplied during the second horizontal period, the second transistor M2 may be turned on. In this case, the data signal supplied to the first output line OL1 may be supplied to a green pixel 15 via the second data line DL2, and the data signal supplied to the second output line OL2 may be supplied to a blue pixel 17 via the fourth data line DL4.

Thus, during the second sub-frame period, data signals corresponding to the same color may be supplied to each of the data lines DL1 to DL4. As an example, a data signal corresponding to green may be supplied to the first data line DL1 and the second data line DL2, a data signal corresponding to red may be supplied to the third data line DL3, and a data signal corresponding to blue may be supplied to the fourth data line DL4 in the second sub-frame period.

That is, in one embodiment of the present invention, data signals corresponding to the same color may be supplied to each of the data lines DL1 to DL4 during the second sub-frame period, thereby reducing or minimizing power consumption. Additionally, data signals corresponding to red and blue may be alternately supplied to the second output line OL2, and the data signal corresponding to green may be supplied to the first output line OL1.

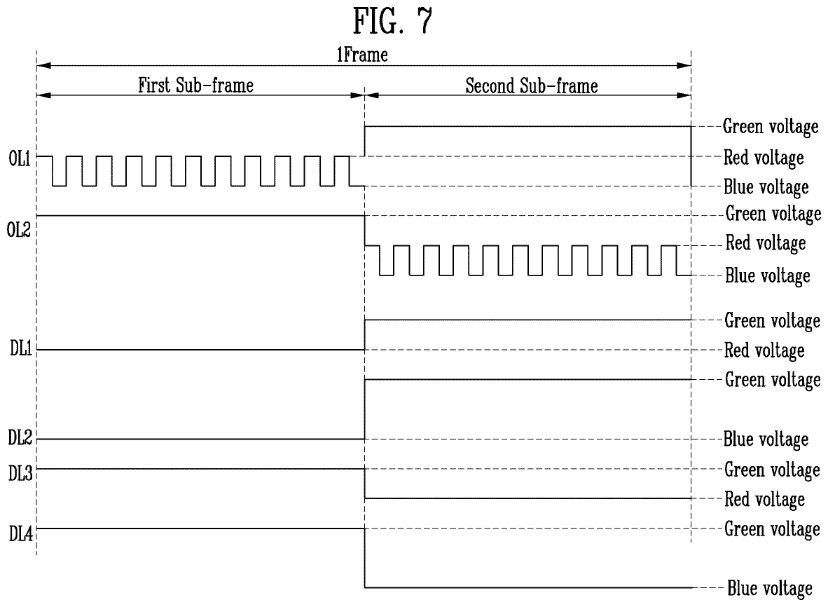

FIG. 7 is a diagram illustrating voltages supplied to output lines and data lines according to the driving method of FIGS. 6A and 6B. In the embodiment of FIG. 7, a green data signal may have a higher voltage than the voltages of a red data signal and a blue data signal. In FIG. 7, also the red data signal may have a higher voltage than the blue data signal.

Referring to FIG. 7, during the first sub-frame period, a voltage of the red data signal (Red voltage) may be supplied to the first data line DL1, a voltage of the blue data signal (Blue voltage) may be supplied to the second data line DL2, and voltages of the green data signal (Green voltage) may be supplied to the third data line DL3 and the fourth data line DL4. Thus, a voltage of the data signal of the same color may be supplied to each of the data lines DL1 to DL4 within the first sub-frame period, even though each of the data lines DL1 to DL4 may be connected to pixels of different colors. Thus, power consumption can be reduced or minimized.

During the second sub-frame period, a voltage of the green data signal (Green voltage) may be supplied to the first data line DL1 and the second data line DL2, a voltage of the red data signal (Red voltage) may be supplied to the third data line DL3, and the voltage of the blue data signal (Blue voltage) may be supplied to the fourth data line DL4. Thus, a voltage of the data signal of the same color may be supplied to each of the data lines DL1 to DL4 during the second sub-frame period, even though each of the data lines DL1 to DL4 may be connected to pixels of different colors. As a result, power consumption can be reduced or minimized.

During the first sub-frame period (where scan signals are supplied to odd-numbered scan lines), voltages of the red and blue data signals may be repeatedly supplied to the first output line OL1, e.g., electrically connected to red pixel 1 and blue pixel 3 shown in FIG. 3. As an example, voltages of the red and blue data signals may be repeatedly supplied to the first output line OL1 every half of horizontal period 1H. During the first sub-frame period, the voltage of the green data signals may be supplied to the second output line OL2, e.g., electrically connected to green pixel 13 and green pixel 4.

During the second sub-frame period (where scan signals are supplied to even-numbered scan lines), voltages of the red and blue data signals may be repeatedly supplied to the second output line OL2, e.g., electrically connected to red pixel 7 and blue pixel 14 shown in FIG. 3. As an example, voltages of the red and blue data signals may be repeatedly supplied to the second output line OL2 every half of horizontal period 1H. During the second sub-frame period, voltages of the green data signals may be supplied to the first output line OL1, e.g., electrically connected to green pixel 2 and green pixel 6.

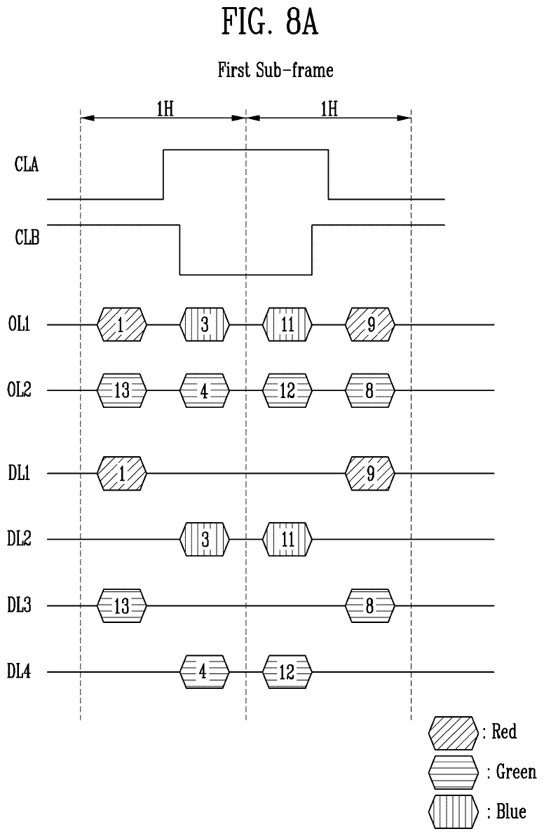

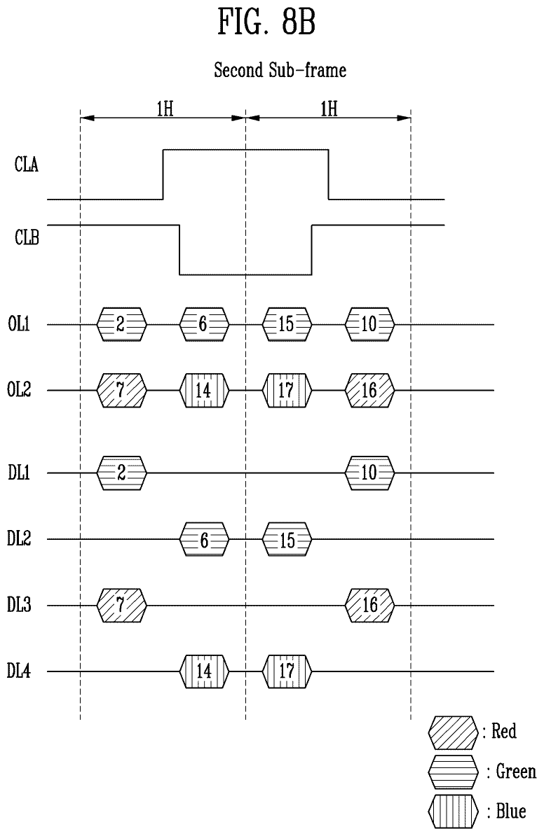

FIGS. 8A and 8B are diagrams illustrating data signals supplied to data lines by a data distributor, e.g., data distributor 150 in FIG. 1. In FIG. 8A and FIG. 8B, the operation process will be described using data signals supplied to the first output line OL1 and the second output line OL2.

Referring to FIG. 8A, during the first sub-frame period, the enable scan signal GW may be sequentially supplied to the odd-numbered scan lines SL1, SL3, . . . .

The enable first control signal CLA and the enable second control signal CLB may be sequentially supplied during the horizontal period 1H. As an example, during the horizontal period 1H, the enable first control signal CLA may be supplied and then the enable second control signal CLB may be supplied.

During the first horizontal period, the enable scan signal GW1 may be supplied to the first scan line SL1. Then, the second transistor T2 included in each of the pixels connected to the first scan line SL1 may be set to a turned-on state.

When the enable first control signal CLA is supplied during the first horizontal period, the first transistors M1 of the demultiplexers may be turned on. When the first transistor M1 is turned on, the first output line OL1 may be electrically connected to the first data line DL1, and the second output line OL2 may be electrically connected to the third data line DL3. In this case, the data signal supplied to the first output line OL1 may be supplied to the first red pixel 1 via the first data line DL1, and the data signal supplied to the second output line OL2 may be supplied to the fifth green pixel 13 via the third data line DL3.

When the enable second control signal CLB is supplied during the first horizontal period, the second transistors M2 of the demultiplexers may be turned on. When the second transistor M2 is turned on, the first output line OL1 may be electrically connected to the second data line DL2, and the second output line OL2 may be electrically connected to the fourth data line DL4. In this case, the data signal supplied to the first output line OL1 may be supplied to the first blue pixel 3 via the second data line DL2, and the data signal supplied to the second output line OL2 may be supplied to the second green pixel 4 via the fourth data line DL4.

During the second horizontal period, the enable scan signal GW3 may be supplied to the third scan line SL3. Then, the second transistor T2 included in each of the pixels connected to the third scan line SL3 may be set to a turned-on state.

During the second horizontal period, the enable second control signal CLB may be supplied and then the enable first control signal CLA may be supplied. The timing controller 140 may change the order in which the enable first control signal CLA and the enable second control signal CLB are supplied for each horizontal period 1H. As an example, the timing controller 140 may supply the enable first control signal CLA and then supply the enable second control signal CLB during the first horizontal period, and may supply the enable second control signal CLB and then supply the enable first control signal CLA during the second horizontal period following the first horizontal period within a sub-frame.

When the enable second control signal CLB is supplied during the second horizontal period, the second transistors M2 of the demultiplexers may be turned on. In this case, the data signal supplied to the first output line OL1 may be supplied to the blue pixel 11 via the second data line DL2, and the data signal supplied to the second output line OL2 may be supplied to the green pixel 12 via the fourth data line DL4.

When the enable first control signal CLA is supplied during the second horizontal period, the first transistors M1 of the demultiplexers may be turned on. In this case, the data signal supplied to the first output line OL1 may be supplied to the red pixel 9 via the first data line DL1, and the data signal supplied to the second output line OL2 may be supplied to the fourth green pixel 8 via the third data line DL3.

Thus, during the first sub-frame period, a data signal corresponding to the same color may be supplied to each of the data lines DL1 to DL4. As an example, a data signal corresponding to red (Red) may be supplied to the first data line DL1, a data signal corresponding to blue (Blue) may be supplied to the second data line DL2, and data signals corresponding to green (Green) may be supplied to the third data line DL3 and the fourth data line DL4.

That is, in one embodiment of the present invention, the data signal corresponding to the same color may be supplied to each of the data lines DL1 to DL4 during the first sub-frame period, thereby reducing or minimizing power consumption. Additionally, data signals corresponding to red and blue may be supplied to the first output line OL1, and data signals corresponding to green may be supplied to the second output line OL2.

Referring to FIG. 8B, during the second sub-frame period, the enable scan signal GW may be sequentially supplied to the even-numbered scan lines SL2, SL4, . . . .

During the first horizontal period, the enable scan signal GW2 may be supplied to the second scan line SL2. Then, the second transistor T2 included in each of the pixels connected to the second scan line SL2 may be set to a turned-on state.

When the enable first control signal CLA is supplied during the first horizontal period, the first transistors M1 of the demultiplexers may be turned on. When the first transistor M1 is turned on, the first output line OL1 may be electrically connected to the first data line DL1, and the second output line OL2 may be electrically connected to the third data line DL3. In this case, the data signal supplied to the first output line OL1 may be supplied to the first green pixel 2 via the first data line DL1, and the data signal supplied to the second output line OL2 may be supplied to the second red pixel 7 via the third data line DL3.

When the enable second control signal CLB is supplied during the first horizontal period, the second transistors M2 of the demultiplexers may be turned on. When the second transistor M2 is turned on, the first output line OL1 may be electrically connected to the second data line DL2, and the second output line OL2 may be electrically connected to the fourth data line DL4. In this case, the data signal supplied to the first output line OL1 may be supplied to the third green pixel 6 via the second data line DL2, and the data signal supplied to the second output line OL2 may be supplied to the third blue pixel 14 via the fourth data line DL4.

During the second horizontal period, the enable scan signal GW4 may be supplied to the fourth scan line SL4. Then, the second transistor T2 included in each of the pixels connected to the fourth scan line SL4 may be set to a turned-on state.

When the enable second control signal CLB is supplied during the second horizontal period, the second transistors M2 of the demultiplexers may be turned on. In this case, the data signal supplied to the first output line OL1 may be supplied to the green pixel 15 via the second data line DL2, and the data signal supplied to the second output line OL2 may be supplied to a blue pixel 17 via the fourth data line DL4.

When the enable first control signal CLA is supplied during the second horizontal period, the first transistors M1 of the demultiplexers may be turned on. In this case, the data signal supplied to the first output line OL1 may be supplied to the green pixel 10 via the first data line DL1, and the data signal supplied to the second output line OL2 may be supplied to the red pixel 16 via the third data line DL3.

Thus, during the second subframe period, a data signal corresponding to the same color may be supplied to each of the data lines DL1 to DL4. For example, data signals corresponding to green may be supplied to the first data line DL1 and the second data line DL2, a data signal corresponding to red may be supplied to the third data line DL3, and a data signal corresponding to blue may be supplied to the fourth data line DL4.

That is, in one embodiment of the present invention, the data signal corresponding to the same color may be supplied to each of the data lines DL1 to DL4 during the second sub-frame period, thereby reducing or minimizing power consumption. Additionally, data signals corresponding to red and blue may be alternately supplied to the second output line OL2, and the data signal corresponding to green may be supplied to the first output line OL1.

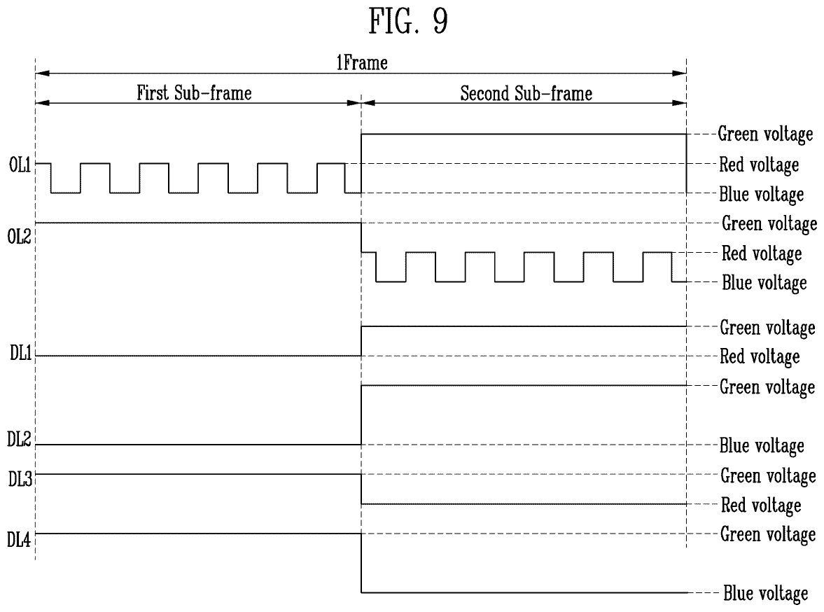

FIG. 9 is a diagram illustrating voltages supplied to output lines and data lines according to the driving method of FIGS. 8A and 8B. In the embodiment of FIG. 9, a green data signal may have a higher voltage than a red data signal and a blue data signal, and the red data signal may have a higher voltage than the blue data signal.

Referring to FIG. 9, during the first sub-frame period, a voltage of the red data signal (Red voltage) may be supplied to the first data line DL1, a voltage of the blue data signal (Blue voltage) may be supplied to the second data line DL2, and voltages of the green data signal (Green voltage) may be supplied to the third data line DL3 and the fourth data line DL4. Thus, a voltage of the data signal of the same color may be supplied to each of the data lines DL1 to DL4, and thus power consumption can be reduced or minimized.

During the second sub-frame period, voltages of the green data signal (Green voltage) may be supplied to the first data line DL1 and the second data line DL2, the voltage of the red data signal (Red voltage) may be supplied to the third data line DL3, and the voltage of the blue data signal (Blue voltage) may be supplied to the fourth data line DL4. Thus, a voltage of the data signal of the same color may be supplied to each of the data lines DL1 to DL4, and thus power consumption can be reduced minimized.

During the first sub-frame period, voltages of the red and blue data signals may be repeatedly supplied to the first output line OL1. As an example, the voltages of the red and blue data signals may be repeatedly supplied to the first output line OL1 every horizontal period of the first sub-frame period. Also, during the first sub-frame period, voltages of the green data signals may be supplied to the second output line OL2.

During the second sub-frame period, the voltages of the red and blue data signals may be repeatedly supplied to the second output line OL2. As an example, the voltages of the red and blue data signals may be repeatedly supplied to the second output line OL2 every horizontal period of the second sub-frame period. Also, during the second sub-frame period, voltages of the green data signals may be supplied to the first output line OL1.

Additionally, the red and blue data signals supplied to the first output line OL1 during the first sub-frame period may be repeatedly supplied every horizontal period, and the red and blue data signals supplied to the second output line OL2 during the second sub-frame period may be repeatedly supplied every horizontal period. In this case, power consumption can be further reduced.

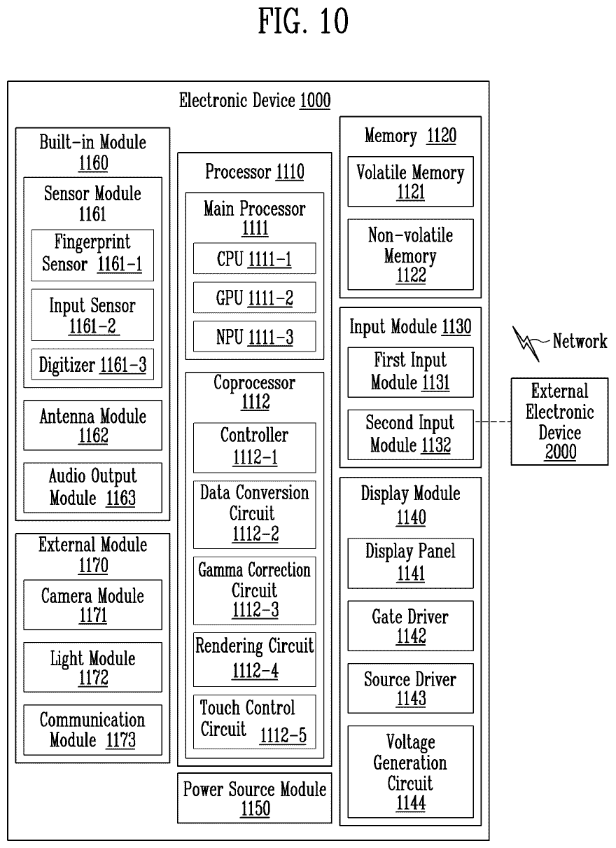

FIG. 10 is a diagram illustrating an electronic device 1000 according to an embodiment of the present invention. The electronic device may be a large electronic device (such as televisions and monitors) or a small and medium-sized electronic device such as mobile phones, tablets, car navigation systems, game consoles, and smart watches.

Referring to FIG. 10, the electronic device 1000 according to one embodiment of the present invention may output various information (e.g., images, text, music, etc.) through a display module 1140, which, for example, may correspond to the display device 100 shown in FIG. 1. When a processor 1110 executes an application stored in a memory 1120, the display module 1140 may provide application information to a user through a display panel 1141.

The processor 1110 may acquire an external input through an input module 1130 or a sensor module 1161 and execute an application corresponding to the external input. For example, when a user selects a camera icon (or a camera application icon) displayed on the display panel 1141, the processor 1110 may acquire a user input through an input sensor 1161-2 and activate a camera module 1171. The processor 1110 may transmit image data corresponding to a captured image acquired through the camera module 1171 to the display module 1140. The display module 1140 may display an image corresponding to the captured image through the display panel 1141.

As another example, when personal information authentication is executed in the display module 1140, a fingerprint sensor 1161-1 may acquire input fingerprint information as input data. The processor 1110 may compare the input data acquired through the fingerprint sensor 1161-1 with authentication data stored in the memory 1120, and execute an application based on the comparison result. The display module 1140 may display information executed according to the logic of the application through the display panel 1141. The fingerprint sensor 1161-1 may be disposed to acquire fingerprint information (e.g., authentication information) throughout (e.g., any location on) the entire area of the display module 1140 (or the display panel 1141).

As another example, when a music streaming icon displayed on the display module 1140 is selected, the processor 1110 may acquire a user input through the input sensor 1161-2 and activate a music streaming application stored in the memory 1120. When a music execution command is input in the music streaming application, the processor 1110 may activate an audio output module 1163 to provide the user with audio information corresponding to the music execution command.

The configuration of the electronic device 1000 will now be described in detail. Some of components of the electronic device 1000 described below may be integrated and provided as one component, and one component may be provided by being divided into two or more components.

The electronic device 1000 may communicate with an external electronic device 2000 via a network (for example, a short-range wireless communication network or a long-range wireless communication network). According to one embodiment, the electronic device 1000 may include the processor 1110, the memory 1120, the input module 1130, the display module 1140, a power source module 1150, a built-in module 1160, and an external module 1170. According to one embodiment, in the electronic device 1000, at least one of the above-described components may be omitted, or one or more other components may be added. According to one embodiment, some of the above-described components (for example, the sensor module 1161, an antenna module 1162, or the audio output module 1163) may be integrated into another component (for example, the display module 1140).

The processor 1110 may execute software to control at least one other component (for example, a hardware or software component) of the electronic device 1000 connected to the processor 1110 and perform various data processing or calculations. According to one embodiment, as at least part of data processing or calculations, the processor 1110 may store commands or data received from another component (for example, the input module 1130, the sensor module 1161, or a communication module 1173) in a volatile memory 1121, process the commands or data stored in the volatile memory 1121, and store resulting data in a non-volatile memory 1122.

The processor 1110 may include a main processor 1111 and an auxiliary or coprocessor 1112. The main processor 1111 may include a central processing unit (CPU) 1111-1. The main processor 1111 may further include one or more of a graphics processing unit (GPU) 1111-2, a communication processor (CP), and an image signal processor (ISP). The main processor 1111 may further include a neural network processing unit (NPU) 1111-3. The neural network processing unit 1111-3 may be a processor specialized in processing artificial intelligence models, and the artificial intelligence models may be generated through machine learning. The artificial intelligence models may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, and a combination of two or more of the above, but the present invention is not limited to the examples described above. In addition to the hardware structure, the artificial intelligence models may additionally or alternatively include a software structure. At least two of the processing units and processors described above may be implemented as a single integrated component (for example, a single chip), or each may be implemented as an independent component (for example, a plurality of chips).

The coprocessor 1112 may include a controller 1112-1. The controller 1112-1 may include an interface conversion circuit and a timing control circuit. As an example, the controller 1112-1 may include the timing controller 140 shown in FIG. 1 for controlling the scan driver 120, data driver 130, and data distributor 150 as previously discussed. The controller 1112-1 may receive an image signal from the main processor 1111, convert the data format of the image signal to match the interface specifications with the display module 1140, and output image data. The controller 1112-1 may output various control signals to drive the display module 1140.

The coprocessor 1112 may further include a data conversion circuit 1112-2, a gamma correction circuit 1112-3, a rendering circuit 1112-4, a touch control circuit 1112-5, and the like. The data conversion circuit 1112-2 may receive input image data from the controller 1112-1 (e.g., image data input into timing controller 140) and may compensate for the image data so that an image is displayed at a desired luminance according to the characteristics of the electronic device 1000 or the user settings, or may convert the image data to reduce power consumption or compensate for afterimages.

The gamma correction circuit 1112-3 may convert the image data, a gamma reference voltage, or the like so that the image displayed on the electronic device 1000 has desired gamma characteristics. The rendering circuit 1112-4 may receive the image data from the controller 1112-1 and render the image data based on the pixel layout of the display panel 1141 applied to the electronic device 1000.

The touch control circuit 1112-5 may supply a touch signal to the input sensor 1161-2 and receive a sensing signal from the input sensor 1161-2 in response to the touch signal.

At least one of the data conversion circuit 1112-2, the gamma correction circuit 1112-3, the rendering circuit 1112-4, or the touch control circuit 1112-5 may be integrated into another component (for example, the main processor 1111 or the controller 1112-1). At least one of the data conversion circuit 1112-2, the gamma correction circuit 1112-3, and the rendering circuit 1112-4 may also be integrated into a source driver 1143 described below.

The memory 1120 may store various data used by at least one component (for example, the processor 1110 or the sensor module 1161) of the electronic device 1000 and input data or output data for commands related thereto. In addition, various setting data corresponding to user settings may be stored in the memory 1120. The memory 1120 may include at least one of the volatile memory 1121 or the non-volatile memory 1122.

The input module 1130 may receive commands or data to be used in components of the electronic device 1000 (for example, the processor 1110, the sensor module 1161, or the audio output module 1163) from outside (for example, the user or the external electronic device 2000) the electronic device 1000.

The input module 1130 may include a first input module 1131 into which commands or data are input from the user, and a second input module 1132 into which commands or data are input from the external electronic device 2000. The first input module 1131 may include a microphone, a mouse, a keyboard, a key (for example, a button), or a pen (for example, a passive pen or an active pen). The second input module 1132 may support a designated protocol that can be connected to the external electronic device 2000 via wired or wireless means. According to one embodiment, the second input module 1132 may include a high definition multimedia interface (HDMI), a universal serial bus (USB) interface, an SD card interface, or an audio interface. The second input module 1132 may include a connector that can be physically connected to the external electronic device 2000, for example, an HDMI connector, a USB connector, an SD card connector, or an audio connector (for example, a headphone connector).

The display module 1140 may output visual information (images) to the user. The display module 1140 may include the display panel 1141, a gate driver 1142, the source driver 1143, and a voltage generation circuit 1144. The display module 1140 may further include a window, a chassis, and a bracket to protect the display panel 1141. The display module 1140 may include at least a part of the configuration of the display device 100 shown in FIG. 1.

The display panel 1141 (or display) may include a liquid crystal display panel, an organic light emitting display panel, or an inorganic light emitting display panel, and the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141. The display panel 1141 may include the display unit 110 shown in FIG. 1. That is, the display panel 1141 may include the pixel PXij shown in FIG. 1, and the pixel PXij may include the pixel circuit and the light emitting element LD show in FIG. 2.

For example, the display panel 1141 may include a Pentile (RGBG) arrangement of color pixels, as shown, for example, in FIG. 3, and may be driven by the scan driver 120 and the data driver 130 through the data distributor 150. The pixels may be driven in units of frames, with each frame driving the pixels in sub-frames. In operation, the data distributor 150 may include a plurality of demultiplexers which output color pixel signals to the pixels of the display panel 1141. The color pixel signals are output so that a same color data signal is output to each of a plurality of data lines of the display unit 110 in each sub-frame. That is, each data line may receive same color data signals during each sub-frame. As described above, this results in reducing or minimizing power consumption.

The gate driver 1142 may correspond to the scan driver 120 and may be mounted on the display panel 1141 as a driving chip. In addition, the gate driver 1142 may be integrated into the display panel 1141. For example, the gate driver 1142 may include an ASG (Amorphous Silicon TFT Gate driver circuit), an LTPS (Low Temperature Polycrystalline Silicon) TFT Gate driver circuit, or an OSG (Oxide Semiconductor TFT Gate driver circuit) embedded in the display panel 1141. The gate driver 1142 may receive one or more control signals (e.g., CK, FLM) from the controller 1112-1 and output scan signals (e.g., GW) to the display panel 1141 in response to the control signal(s).

The display module 1140 may further include an emission driver. The emission driver may output an emission control signal to the display panel 1141 in response to a control signal received from the controller 1112-1. The emission driver may be formed separately from the gate driver 1142 or may be integrated into the gate driver 1142.

The source driver 1143 may receive a control signal from the controller 1112-1, convert the image data into an analog voltage (for example, a data signal) in response to the control signal, and then output data signals to the display panel 1141. The source driver 1143 may include the data driver 130 shown in FIG. 1. In addition, the source driver 1143 may include the data distributor 150 shown in FIG. 1.

The source driver 1143 may be integrated into another component (for example, the controller 1112-1). The functions of the interface conversion circuit and the timing control circuit of the controller 1112-1 described above may also be integrated into the source driver 1143. The voltage generation circuit 1144 may output various voltages to drive the display panel 1141. As an example, the voltage generation circuit 1144 may generate the first driving power source VDD and the second driving power source VSS shown in FIG. 2.

In one embodiment, the source driver 1143 may convert data corresponding to a combination of colors (e.g., red (R), green (G), and blue (B)) included in the image data received from the processor 1110 into a red data signal (or data voltage), one or more green data signals, and a blue data signal, and provide them to a plurality of pixel rows included in the display panel 1141 during one horizontal period.

The power source module 1150 may supply power to the components of the electronic device 1000. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power source to each of the modules described above and the modules described below. The power source module 1150 may include a wireless power transceiver member electrically connected to the battery. The wireless power transceiver member may include a plurality of coil-shaped antenna radiators. In one embodiment, at least some of the configurations of the power source module 1150 and the voltage generation circuit 1144 may be provided as one integrated unit. As an example, the voltage generation circuit 1144 may be included in the power source module 1150.

The electronic device 1000 may further include a built-in module 1160 and an external module 1170. The built-in module 1160 may include the sensor module 1161, the antenna module 1162, and the audio output module 1163. The external module 1170 may include the camera module 1171, a light module 1172, and the communication module 1173.

The sensor module 1161 may detect an input by a part (e.g., finger) of a user's body or an input by the pen of the first input module 1131, and generate an electric signal or data value corresponding to the input. The sensor module 1161 may include at least one of the fingerprint sensor 1161-1, the input sensor 1161-2, and a digitizer 1161-3.

The fingerprint sensor 1161-1 may generate a data value corresponding to a user's fingerprint.

The input sensor 1161-2 may generate a data value corresponding to coordinate information of the input by the user's body or the input by the pen. The input sensor 1161-2 may generate the amount of change in capacitance due to the input as the data value. The input sensor 1161-2 may detect an input by a passive pen or transmit and receive data with an active pen.

The input sensor 1161-2 may also measure one or more biological signals such as blood pressure, moisture, or body fat. For example, when a user touches a part of his or her body to a sensor layer or sensing panel and does not move for a certain period of time, the input sensor 1161-2 may detect a biological signal based on a change in electric field caused by the part of his or her body and output information desired by the user to the display module 1140.

The digitizer 1161-3 may generate a data value corresponding to coordinate information of the input by the pen. The digitizer 1161-3 may generate the amount of change in electromagnetic due to the input as the data value. The digitizer 1161-3 may detect an input by a passive pen or transmit and receive data with an active pen.

At least one of the fingerprint sensor 1161-1, the input sensor 1161-2, or the digitizer 1161-3 may be implemented as a sensor layer formed on the display panel 1141 through a continuous process. At least one of the fingerprint sensor 1161-1, the input sensor 1161-2, or the digitizer 1161-3 may be disposed on an upper side of the display panel 1141, and any one of the fingerprint sensor 1161-1, the input sensor 1161-2, or the digitizer 1161-3, for example, the digitizer 1161-3, may be disposed on a lower side of the display panel 1141.

At least two of the fingerprint sensor 1161-1, the input sensor 1161-2, and the digitizer 1161-3 may be formed to be integrated into one sensing panel through the same process. When integrated into one sensing panel, the sensing panel may be disposed between the display panel 1141 and a window disposed on the upper side of the display panel 1141. According to one embodiment, the sensing panel may also be disposed on the window, and the position of the sensing panel is not particularly limited.

At least one of the fingerprint sensor 1161-1, the input sensor 1161-2, and the digitizer 1161-3 may be built into the display panel 1141. For example, at least one of the fingerprint sensor 1161-1, the input sensor 1161-2, or the digitizer 1161-3 may be formed simultaneously through a process of forming elements (for example, the light emitting element, the transistor, and the like) included in the display panel 1141.

In addition, the sensor module 1161 may generate an electric signal or data value corresponding to an internal state or an external state of the electronic device 1000. The sensor module 1161 may further include, for example, a gesture sensor, a gyro sensor, a pressure sensor, a magnetic sensor, an acceleration sensor, a grip sensor, a proximity sensor, a color sensor, an infrared (IR) sensor, a biometric sensor, a temperature sensor, a humidity sensor, or a light sensor.

The antenna module 1162 may include one or more antennas for transmitting signals or power to the outside or receiving signals from the outside. According to one embodiment, when the electronic device is a smart phone, the communication module 1173 may transmit signals to an external electronic device (e.g., another smart phone) or receive signals from the external electronic device through an antenna suitable for a communication method. An antenna pattern of the antenna module 1162 may be integrated into one component (for example, the display panel 1141) of the display module 1140, the input sensor 1161-2, or the like.

The audio output module 1163 may be a device for outputting an audio signal from the electronic device 1000, and may include, for example, a speaker used for general purposes such as multimedia playback or recording playback, and a receiver used exclusively for telephone reception. According to one embodiment, the receiver may be formed integrally with or separately from the speaker. An audio output pattern of the audio output module 1163 may also be integrated into the display module 1140.

The camera module 1171 may capture a still image and a moving image. According to one embodiment, the camera module 1171 may include one or more lenses, image sensors, or image signal processors. The camera module 1171 may further include an infrared camera that can measure the presence or absence of a user, the location of a user, the line of sight of a user, and the like.

The light module 1172 may provide light to operate as a flash light or a flash for the camera module 1171. The light module 1172 may include a light emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and performance of communication through the established communication channel. The communication module 1173 may include one or both of a wireless communication module, such as a cellular communication module, a short-range wireless communication module, or a GNSS (global navigation satellite system) communication module, and a wired communication module, such as a LAN (local area network) communication module or a power line communication module. The communication module 1173 may communicate with the external electronic device 2000 via a short-range communication network such as Bluetooth, WiFi direct, or IrDA (infrared data association), or a long-range communication network such as a cellular network, the Internet, or a computer network (for example, LAN or WAN). The various types of communication modules 1173 described above may be implemented as one chip or as separate chips.

The input module 1130, the sensor module 1161, the camera module 1171, and the like may be used to control the operation of the display module 1140 in conjunction with the processor 1110.

The processor 1110 may output a command (e.g., one or more control signals to the timing controller 140) or data to the display module 1140, the audio output module 1163, the camera module 1171, or the light module 1172 based on the input data received from the input module 1130. For example, the processor 1110 may generate the image data in response to the input data received through a mouse, an active pen, or the like and output the image data to the display module 1140, or generate command data in response to the input data and output the command data to the camera module 1171 or the light module 1172. When the input data is not received from the input module 1130, the processor 1110 may switch the operation mode of the electronic device 1000 to a low power mode or sleep mode to reduce power consumption of the electronic device 1000.

The processor 1110 may output a command or data to the display module 1140, the audio output module 1163, the camera module 1171, or the light module 1172 based on sensing data received from the sensor module 1161. For example, the processor 1110 may compare authentication data authorized by the fingerprint sensor 1161-1 with the authentication data stored in the memory 1120, and then execute an application based on the comparison result. The processor 1110 may execute a command or output corresponding image data to the display module 1140 based on sensing data detected by the input sensor 1161-2 or the digitizer 1161-3. When a temperature sensor is included in the sensor module 1161, the processor 1110 may receive temperature data on the temperature measured from the sensor module 1161 and further perform luminance correction and the like on the image data based on the temperature data.

The processor 1110 may receive measurement data on the presence or absence of a user, the location of a user, the line of sight of a user, and the like from the camera module 1171. The processor 1110 may further perform luminance correction and the like on the image data based on the measurement data. For example, the processor 1110 that determines the presence or absence of a user based on an input from the camera module 1171 may output image data whose luminance is corrected through the data conversion circuit 1112-2 or the gamma correction circuit 1112-3 to the display module 1140.

Some of the components described above may be interconnected with each other through a communication method between peripheral devices, such as a bus, GPIO (general purpose input/output), SPI (serial peripheral interface), MIPI (mobile industry processor interface), or UPI (ultra path interconnect) link, to exchange signals (for example, commands or data) with each other. The processor 1110 may communicate with the display module 1140 through a mutually agreed upon interface. For example, any one of the above-described communication methods may be used, and is not limited to the above-described communication methods.

According to the display device according to the embodiments of the present invention, a display device may be driven in units of a frame. One frame may be divided into a first sub-frame period and a second sub-frame period. A data driver may output color image signals to pixels, through a data distributor, during the first and second sub-frames and data signals. During each sub-frame, data signals of the same color may be supplied to each data line via the data distributor. When data signals of the same color are supplied to the data lines, power consumption can be reduced or minimized.

However, effects of the present invention are not limited to the above-described effects, and may be variously extended without departing from the spirit and scope of the present invention.

As described above, preferred embodiments of the present invention have been described with reference to the drawings. However, those skilled in the art will appreciate that various modifications and changes can be made to the present invention without departing from the spirit and scope of the invention as set forth in the appended claims. The embodiments may be combined to form additional embodiments.

What is claimed is:

1. A display device comprising:
pixels arranged in an order of a first red pixel, a first green pixel, a first blue pixel, and a second green pixel on a first horizontal line; and
pixels arranged in the order of a second blue pixel, a third green pixel, a second red pixel, and a fourth green pixel on a second horizontal line,
wherein the first red pixel and the second blue pixel located on a same vertical line are connected to different data lines, and
wherein the first green pixel and the second green pixel located on the first horizontal line are connected to different scan lines.

2. The display device of claim 1, wherein the first green pixel and the third green pixel located on the same vertical line are connected to different data lines,
wherein the first blue pixel and the second red pixel located on the same vertical line are connected to different data lines, and
wherein the second green pixel and the fourth green pixel located on the same vertical line are connected to different data lines.

3. The display device of claim 2, wherein the first green pixel and the third green pixel are connected to the same scan line.

4. The display device of claim 2, wherein the second green pixel and the fourth green pixel are connected to different scan lines.

5. The display device of claim 2, wherein the first red pixel, the first blue pixel, and the second green pixel are connected to a first scan line, and
wherein the second blue pixel, the first green pixel, the third green pixel, and the second red pixel are connected to a second scan line.

6. The display device of claim 5, further comprising:
a fifth green pixel located on the same vertical line as the second green pixel above the second green pixel, wherein the fifth green pixel is connected to the first scan line.

7. The display device of claim 2, wherein the first red pixel and the first green pixel are connected to a first data line,
wherein the first blue pixel and the third green pixel are connected to a second data line,
wherein the second red pixel and the fourth green pixel are connected to a third data line, and
wherein the second green pixel is connected to a fourth data line.

8. The display device of claim 7, further comprising:
a third blue pixel located adjacent to the fourth green pixel in the second horizontal line and connected to the fourth data line.

9. The display device of claim 7, further comprising:
a data driver configured to supply a plurality of data signals to output lines;
a data distributor configured to output the plurality of data signals input to the output lines to a plurality of data lines;
a scan driver configured to drive scan lines; and
a timing controller configured to control the data driver, the data distributor, and the scan driver.

10. The display device of claim 9, wherein the data distributor includes:
a first demultiplexer connected to a first output line among the output lines and transmitting data signals to the first data line and the second data line; and
a second demultiplexer connected to a second output line among the output lines and transmitting data signals to the third data line and the fourth data line.

11. The display device of claim 10, wherein each of the first demultiplexer and the second demultiplexer includes:
a first transistor turned on in response to an enable first control signal supplied from the timing controller; and
a second transistor turned on in response to an enable second control signal supplied from the timing controller.

12. The display device of claim 11, wherein the timing controller sequentially supplies the enable first control signal and the enable second control signal during a horizontal period.

13. The display device of claim 11, wherein the timing controller:
supplies the enable first control signal and then supplies the enable second control signal during a first horizontal period, and
supplies the enable second control signal and then supplies the enable first control signal during a second horizontal period following the first horizontal period.

14. The display device of claim 9, wherein one frame is divided into a first sub-frame and a second sub-frame, and
wherein the scan driver sequentially supplies an enable scan signal to k-th scan lines during a first sub-frame period, and sequentially supplies an enable scan signal to (k+1)th scan lines during a second sub-frame period (k is an odd or even number).

15. A display device comprising:
pixels connected to scan lines and data lines;
a scan driver configured to drive the scan lines;
a data driver configured to supply a plurality of data signals to output lines; and
a data distributor connected to the output lines and configured to supply the plurality of data signals in time division to the data lines,
wherein the pixels located on a same vertical line and emit light of different colors are alternately connected to different data lines, and
wherein the pixels that are located on the same vertical line and different horizontal lines and emit light of a same color are connected to the same scan line and are driven in the same sub-frames of a frame.

16. The display device of claim 15, wherein the pixels that emit light of the same color are green pixels, and the green pixels located on the same horizontal line are alternately connected to different scan lines.

17. The display device of claim 15, wherein the frame is divided into a first sub-frame and a second sub-frame, and
wherein the scan driver sequentially supplies an enable scan signal to odd-numbered scan lines during a first sub-frame period, and sequentially supplies an enable scan signal to even-numbered scan lines during a second sub-frame period.

18. The display device of claim 15, wherein:
the data distributor has a demultiplexer connected between one output line and two data lines, and
the demultiplexer sequentially connects the one output line to the two data lines during a horizontal period in response to an enable first control signal and an enable second control signal, and wherein the display device further comprises:
a timing controller configured to supply the enable first control signal and the enable second control signal, wherein the timing controller:
sequentially supplies the enable first control signal and the enable second control signal for each horizontal period, or
changes an order in which the enable first control signal and the enable second control signal are supplied for each horizontal period.

19. An electronic device comprising:
a display device; and
a power source to supply power to the display device,
wherein the display device includes:
a plurality of pixels;
a data driver configured to output color data signals;
a distributor configured to provide the color data signals to data lines connected to the plurality of pixels, wherein the plurality of pixels are to be driven in an interlaced scanning pattern, and wherein the plurality of pixels include:
pixels arranged in an order of a first red pixel, a first green pixel, a first blue pixel, and a second green pixel on a first horizontal line, the first red pixel, the first blue pixel, and the second green pixel to emit light during a first sub-frame period; and
pixels arranged in the order of a second blue pixel, a third green pixel, a second red pixel, and a fourth green pixel on a second horizontal line, the first green pixel, the second blue pixel, the third green pixel and the second red pixel to emit light during a second sub-frame period,
wherein the first red pixel and the second blue pixel located on a same vertical line are connected to different data lines, and
wherein the first green pixel and the second green pixel located on the first horizontal line are connected to different scan lines.

20. The electronic device of claim 19, wherein the first green pixel and the third green pixel located on the same vertical line are connected to different data lines,
wherein the first blue pixel and the second red pixel located on the same vertical line are connected to different data lines, and
wherein the second green pixel and the fourth green pixel located on the same vertical line are connected to different data lines.
